(19) United States
(12) Patent Application Publication
(10) Pub. No.: US 2026/0111083 A1
(43) Pub. Date: Apr. 23, 2026

(54) DISPLAY DEVICE

(71) Applicant: LG Display Co., Ltd., Seoul (KR)

(72) Inventors: Hyunwoo JANG, Paju-si (KR); Sojung JUNG, Paju-si (KR)

(73) Assignee: LG Display Co., Ltd., Seoul (KR)

(21) Appl. No.: 19/364,994

(22) Filed: Oct. 21, 2025

(30) Foreign Application Priority Data
Oct. 21, 2024 (KR) 10-2024-0144097

(51) Int. Cl. G06F 3/041

(52) U.S. Cl. CPC G06F 3/04166; G06F 3/0412

(57) ABSTRACT

A display device as described herein includes a microcontroller configured to operate in both an active mode and an idle mode, and includes a core configured to determine a touch position, a clock generator configured to generate a clock signal, and a first Pulse Width Modulation (PWM) generator configured to generate a PWM signal in the active mode using the clock signal, wherein the core operates at a reduced speed and power consumption in the idle mode compared to the active mode. The display device further includes a touch driver including a second PWM generator configured to generate a PWM signal based on a high pulse width, a low pulse width, a pulse count, and initial interval information of a PWM signal generated by the first PWM generator, wherein the touch driver determines whether a touch has occurred in the idle mode.

### CROSS-REFERENCE TO RELATED APPLICATION

This application claims priority to Korean Patent Application No. 10-2024-0144097, filed in the Republic of Korea on Oct. 21, 2024, the disclosure of which is incorporated herein by reference in its entirety.

### BACKGROUND

### Technical Field

Embodiments of the present disclosure relate to a display device.

### Discussion of the Related Art

As the information society develops, demands for various display devices, such as liquid crystal displays and organic light emitting diode displays, increase. Various images displayed on such display devices can include still images or moving images, and various types of moving images can include, for example, a sports image, a game image, a movie, etc. Unfortunately, display device can require an excessive amount of power, and various internal components have a limited lifespan.

### SUMMARY OF THE DISCLOSURE

One object of embodiments of the present disclosure is to solve the above-noted disadvantages, and embodiments of the present disclosure can provide a display device reducing power consumption and extending the life of a microcontroller. Aspects according to the present disclosure are not limited to the above ones, and other aspects and advantages not mentioned above can be clearly understood from the following description and can be more clearly understood from the embodiments set forth herein.

To solve the objects of the present disclosure, a display device according to one embodiment of the present disclosure can include a microcontroller including a core configured to operate in an active mode to perform an operation for determining a user's touch position, and a first PWM (Pulse Width Modulation) generator configured to generate a PWM signal in the active mode; a touch driver comprising a second PWM generator configured to generate a PWM signal based on a high pulse width, a low pulse width, a pulse count, and initial interval information of a PWM signal generated by the first PWM generator in an idle mode for determining whether a user's touch has occurred; a timing controller configured to generate a touch synchronization signal supplied to the microcontroller and the touch driver; and a plurality of touch electrodes configured to receive a common voltage generated based on the PWM signal and be driven in the active mode or the idle mode.

In another aspect, a display device according to another embodiment can include a microcontroller including a first PWM generator configured to generate a PWM signal in an active mode for determining a user's touch position; a touch driver comprising a second PWM generator configured to generate a PWM signal based on a high pulse width, a low pulse width, a pulse count, and initial interval information of a PWM signal generated by the first PWM generator in an idle mode for determining whether a user's touch occurs; and a plurality of touch electrodes configured to receive a common voltage generated based on the PWM signal to be driven in the active mode or the idle mode. Specific descriptions of other embodiments are provided in detailed description and the accompanying drawings.

According to the embodiments of the present disclosure, the display device can reduce power consumption and extend the life of the microcontroller by turning off the operation of the core, SPI master, SRAM, and first PWM generator of the microcontroller in idle mode. Furthermore, according to the embodiments of the present disclosure, the display device may turn off the first PWM generator of the microcontroller by generating a PWM signal based on the PWM signal generated by the first PWM generator in the idle mode of the touch driver. In addition to the above-described effects, specific effects of the present invention will be described together with the following detailed description for implementing the present invention.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a plane view showing a display device according to one embodiment;

FIG. 2 is a block view showing a display device according to one embodiment;

FIG. 3 is a view showing a channel multiplexer of a display device according to one embodiment;

FIG. 4 is a block view showing the operation of a microcontroller and a touch driver in an active mode in a display device according to one embodiment;

FIG. 5 is a waveform view showing a PWM signal in an active mode in a display device according to one embodiment;

FIG. 6 is a block diagram showing the operation of a microcontroller and a touch driver in an idle mode in a display device according to one embodiment;

FIG. 7 is a waveform view showing a PWM signal and the operation of a microcontroller and a touch driver in an idle mode in a display device according to one embodiment;

FIG. 8 is a block diagram showing the operation of a microcontroller and a touch driver in an idle mode in a display device according to another embodiment;

FIG. 9 is a flowchart showing a touch sensing process in a display device according to one embodiment;

FIG. 10 is a view showing a pulse width generation of a second PWM generator in a display device according to one embodiment;

FIG. 11 is a waveform diagram showing the operation of a pulse width generation of a second PWM generator in a display device according to one embodiment;

FIG. 12 is a circuit view showing a pulse number generation circuit of a second PWM generator in a display device according to one embodiment;

FIG. 13 is a waveform diagram showing the operation of a pulse number generation circuit of a second PWM generator in a first frame in a display device according to one embodiment;

FIG. 14 is a waveform view showing the operation of a pulse number generation circuit of a second PWM generator in a second frame in a display device according to one embodiment;

FIG. 15 is a circuit view showing a pulse generation circuit of a second PWM generator in a display device according to one embodiment;

FIG. 16 is a waveform diagram showing the operation of a pulse generation circuit of a second PWM generator in a display device according to one embodiment;

FIG. 17 is a circuit diagram showing a pulse width generation circuit of a second PWM generator in a display device according to another embodiment; and

FIG. 18 is a waveform view showing the operation of a pulse width generation circuit of a second PWM generator in a display device according to another embodiment.

### DETAILED DESCRIPTION OF THE EMBODIMENTS

Hereinafter, description will now be given in detail according to exemplary embodiments disclosed herein, with reference to the accompanying drawings. In the present disclosure, when a component (or region, layer, portion, etc.) is said to be “on,” “connected,” or “coupled” to another component, it means that it can be directly connected/coupled to the other component, or a third component may be arranged between them. Below, preferred embodiments according to the disclosure are specifically described with reference to the accompanying drawings. In the drawings, identical reference numerals can denote identical or similar components. These terms are generally only used to distinguish one element from another. It will be understood that the terms “first” and “second” are used herein to describe various components but these components should not be limited by these terms. The above terms are used only to distinguish one component from another. For example, a first component may be referred to as a second component and vice versa without departing from the scope of the invention. The singular expressions include plural expressions unless the context clearly dictates otherwise. Terminologies such as “under,” “below,” “on,” “above,” and etc. are used to describe location relationship between the elements shown in the drawings. Such terminologies are relative concepts and described with respect to directions shown in the accompanying drawings. In contrast, when an element is referred to as being “directly connected with” another element, there are no intervening elements present. Unless “immediately” or “directly” is used when describing location relationship, for example, “on,” “above,” “under,” “next,” etc., one or more other elements may be also present.

Throughout the disclosure, each component can be provided as a single one or a plurality of ones, unless explicitly stated to the contrary. Terms such as “include” or “comprise” are used herein and should be understood that they are intended to indicate an existence of several components, functions or steps, disclosed in the specification, and it is also understood that greater or fewer components, functions, or steps may likewise be utilized. A singular representation may include a plural representation unless it represents a definitely different meaning from the context. In understanding the components, it should be understood as including the error range.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.” Also, the following embodiments can be partially or entirely bonded to or combined with each other and can be linked and operated in technically various ways. The embodiments can be carried out independently of or in association with each other.

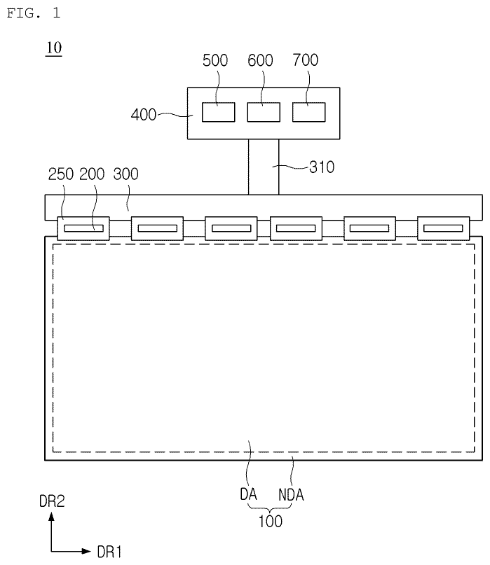

FIG. 1 is a plane view showing a display device 10 according to one embodiment. Referring to FIG. 1, the display device 10 can be applied to portable electronic devices such as a mobile phone, a smart phone, a tablet personal computer (PC), a mobile communication terminal, an electronic notebook, an electronic book, a portable multimedia player (PMP), a navigation device, an ultra mobile PC (UMPC), etc. For example, the display device 10 can be applied to a television, a laptop, a monitor, a billboard, or a display of the Internet of Things (IOT). For another example, the display device 10 can be applied to a wearable device such as a smart watch, a watch phone, a glasses-type display, and a head mounted display (HMD). The display device 10 can include a display panel 100, a display driver 200, a flexible film 250, a source circuit board 300, a flexible cable 310, a control circuit board 400, a timing controller 500 a power supply unit 600, and a memory 700.

The display panel 100 can include a display area DA and a non-display area NDA. The display area DA can include a plurality of pixels displaying an image. Each of the pixels can emit light from a light-emitting area or an aperture area. For example, the display area DA can include a pixel circuit including switching elements, a pixel definition film defining a light-emitting area, and a self-light emitting element. The self-light emitting element can also include at least one of an organic light emitting diode OLED including an organic light emitting layer, a quantum dot LED including a quantum dot LED, an inorganic LED including an inorganic semiconductor, and an ultra-small light emitting diode (e.g., a micro LED or nano LED), but the embodiments are not limited thereto.

In addition, the display driving unit 200 can include a data driver 210 supplying a data voltage, and a touch driver 220 supplying a touch signal. The display driving unit 200 can be implemented as an integrated circuit in which the data driver 210 and the touch driver 220 are integrated. For example, the display driving unit 200 can be attached to one surface of a flexible film 250 in a COF (Chip on Film) manner. The flexible film 250 can include lines electrically connected to the display driving unit 200 and the display panel 100. One side of the flexible film 250 can be electrically connected to a pad portion of the display panel 100, and the other side of the flexible film 250 can be electrically connected to a source circuit board 300.

Further, the source circuit board 300 can electrically connect the control circuit board 400 and the flexible film 250. Also, the source circuit board 300 can be a printed circuit board including lines electrically connecting the display driver 200 and other devices. In addition, the source circuit board 300 can be electrically connected to the control circuit board 400 via a flexible cable 310. For example, the flexible cable 310 can be a flexible flat cable (FFC), but is not limited thereto.

Further, the control circuit board 400 can be a printed circuit board on which is mounted, for example, the timing controller 500, a power supply unit 600, and a memory 700. Further, without being limited to the illustration in FIG. 1, the control circuit board 400 can mount control components and various electrical devices. The timing controller 500 can also be attached to one side of the control circuit board 400 and can control the driving timing of the display driving unit 200 by transmitting digital video data to the display driving unit 200. The power supply unit 600 may generate a power voltage and supply it to the display panel 100. Here, the power voltage may include, but is not limited to, a first driving voltage (EVDD), a second driving voltage (EVSS), an initialization voltage (Vint), a reference voltage (Vref), and a bias voltage (Vbias).

Further, the memory 700 can store sensing information of pixels. For example, the memory 700 can store threshold voltage information of a transistor received from the display driving unit 200 and supply the threshold voltage information to the timing controller 500.

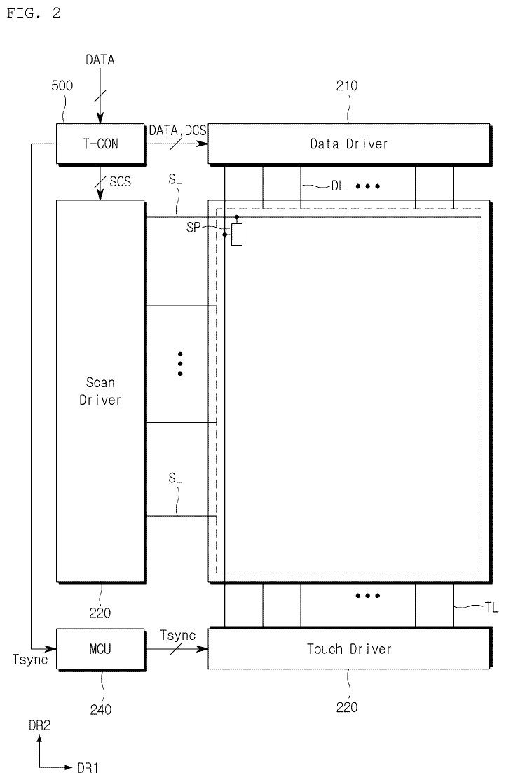

In addition, FIG. 2 is a block view showing a display device according to one embodiment. Referring to FIG. 2, the display panel 100 can include a display area DA and a non-display area NDA. In particular, the display area DA can include a plurality of pixels SP, scan lines SL connected to the pixels SP, and data lines DL connected to the pixels SP. Each of the pixels SP can be connected to the scan lines SL and the data lines DL. In addition, each of the pixels SP can include a transistor, a light-emitting element, and a capacitor. The scan lines SL can extend in a first direction DR1 and can be spaced apart from each other in a second direction DR2 intersecting the first direction DR1. In operation, the scan lines SL can sequentially supply scan signals to the pixels SP. Further, the data lines DL can extend in a second direction DR2 and can be spaced apart from each other in the first direction DR1. In operation, the data line DL can supply a data voltage to the pixel SP. The data voltage can determine the brightness of the pixel SP.

In addition, the display drive unit 200 can include a data driver 210 and a touch driver 220. The display drive unit 200 can be implemented as an integrated circuit in which the data driver 210 and the touch driver 220 are integrated. The data driver 210 can also convert digital video data DATA into an analog data voltage and supply a data voltage to a data line DL through a fan out line based on a data control signal DCS. Further, the data driver 210 can be electrically connected to the data line of the display panel 100 through a flexible film 250 and a pad portion of the display panel 100.

Further, the touch driver 220 can supply a touch driving signal to the touch electrode of the display panel 100 through a touch line TL. In various examples, the touch driving signal can be a PWM (Pulse Width Modulation) signal having a predetermined frequency. In operation, the touch driver 220 can sense the amount of change in the electrostatic capacitance of the touch electrode. Accordingly, the touch driver 220 can determine whether a touch occurs based on the amount of change in the electrostatic capacitance of the touch electrode and calculate the touch coordinate.

In addition, the scan driver 230 can include a plurality of transistors and can generate scan signals based on a scan control signal SCS received from the timing controller 500. In various embodiments, the scan driver 230 can be arranged on one side or both sides of the non-display area NDA in a GIP (Gate In Panel) manner. In operation, the scan driver 230 can shift scan signals using a shift register and sequentially supply the shifted scan signals to scan lines SL. Further, the scan signals of the scan driver 230 can also select pixels SP to which data voltage is supplied, and the selected pixels SP can receive the data voltage through data lines DL.

Further, the microcontroller 240 can control the touch sensing operation of the touch driver 220. More specifically, the microcontroller 240 can supply a touch synchronization signal (Tsync) received from the timing controller 500 to the touch driver 220 and transmit and receive signals to and from the touch driver 220 based on a predefined interface.

In addition, the timing controller 500 can receive digital video data (DATA) and timing signals from a display driving system or a graphic device. The timing controller 500 can also generate a data control signal DCS based on the timing signals. Further, the timing controller 500 can supply the digital video data DATA and the data control signal DCS to the data driver 210 to control the operation timing of the data driver 210. Still further, the timing controller 500 generate a scan control signal SCS based on the timing signals, and supply the scan control signal SCS to the scan driver 230 to control the operation timing of the scan driver 230.

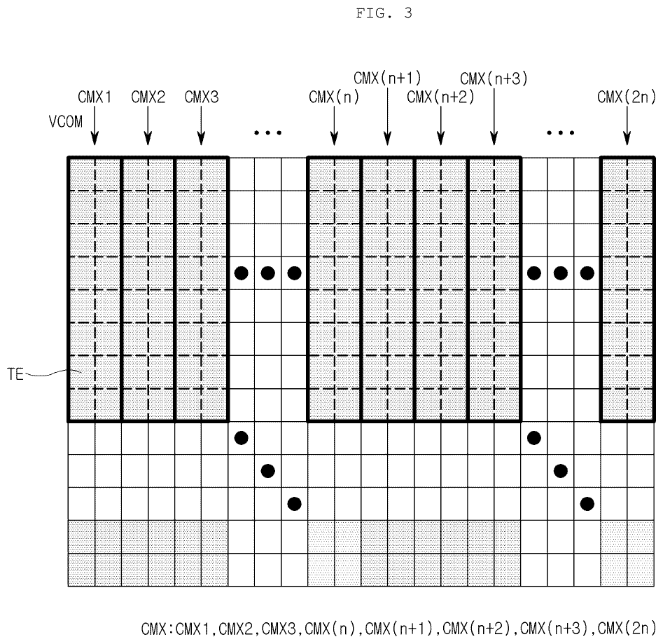

Next, FIG. 3 is a view showing a channel multiplexer of a display device according to one embodiment. Referring to FIG. 3, the display panel 100 can include a plurality of touch electrodes TE. In more detail, the touch driver 220 can supply a common voltage VCOM to the touch electrodes TE through a plurality of channel multiplexers CMX, and one channel multiplexer CMX can supply a common voltage VCOM to touch electrodes TE arranged in at least one column. Also, referring to FIG. 3, one channel multiplexer CMX can supply a common voltage VCOM to touch electrodes TE arranged in two columns, but the configuration of the channel multiplexer CMX is not limited thereto. The example plurality of channel multiplexers CMX of FIG. 3 includes first to second n-th channel multiplexers (CMX1, CMX2, . . . , and CMX(2n), where n is a positive integer).

In addition, the touch driver 220 can sense a user's touch through an active mode and an idle mode. In the active mode, the touch driver 220 can sequentially supply a common voltage VCOM to each of the first to second n-th channel multiplexers CMX1, CMX2, . . . , and CMX(2n). Also, the touch driver 220 can determine a touch position of the user by determining a channel multiplexer CMX in which the user's touch is sensed in the active mode. In the idle mode, the touch driver 220 can determine whether a touch has occurred by the user by merging a plurality of channel multiplexers CMX into at least one group, and the plurality of channel multiplexers CMX can be merged into one group by being shorted. For example, the touch driver 220 can merge the first to n-th channel multiplexers CMX1, CMX2, . . . , and CMX(n) in the idle mode and simultaneously supply a common voltage VCOM to the first to n-th channel multiplexers CMX1, CMX2, . . . , CMX(n). The touch driver 220 can also simultaneously supply a common voltage (VCOM) to the n+1 to 2n channel multiplexers CMX(n+1), CMX(n+2), . . . , and CMX(2n) by merging the n+1 to 2n channel multiplexers CMX(n+1), CMX(n+2), . . . , and CMX(2n) in the idle mode.

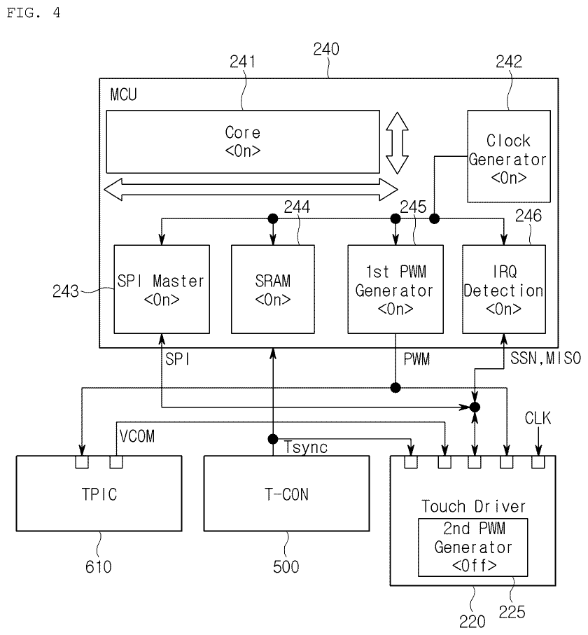

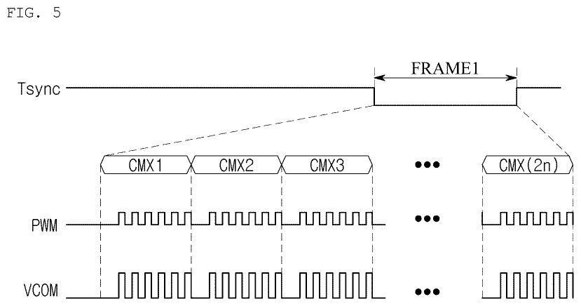

Next, FIG. 4 is a block view showing the operation of a microcontroller 240 and a touch driver 220 in an active mode in a display device according to one embodiment. Also, FIG. 5 is a waveform view showing a PWM signal in an active mode in a display device according to one embodiment. Referring to FIGS. 4 and 5, the microcontroller 240 can control the touch sensing operation of the touch driver 220. As shown, the microcontroller 240 can include a core 241, a clock generator 242, an SPI (Serial Peripheral Interface) master 243, an SRAM (Static Random Access Memory) 244, a first PWM generator 245, and an IRQ (Interrupt Request) detection unit (circuit) 246.

The core (circuit) 241 can include a number of devices common to microcontrollers, such as Arithmetic and Logic Units (ALUs), and number of registers, a control unit, buses, and cache memory. The core circuit 241, as well as other portions of the microprocessor 240, can include CMOS circuitry, NMOS circuitry, PMOS circuitry, or bipolar transistors.

The core circuit 241 can operate in an active mode to perform an operation for determining a touch position. Further, the core circuit 241 can receive an SPI signal having touch data from the touch driver 220 through the SPI master 243. In addition, the core circuit 241 can perform an operation based on the touch data to calculate touch coordinates.

Also, the clock generator 242 can operate on in the active mode to generate a clock signal. Further, the clock generator 242 can supply the clock signal to the SPI master 243, the SRAM 244, the first PWM generator 245, and the IRQ detection unit 246.

In addition, the SPI master 243 can operate on in the active mode and perform bidirectional data communication using the SPI signal between the microcontroller 240 and peripheral devices. The SRAM 244 can also operate on in the active mode to store touch data included in the SPI signal. Further, the SRAM 244 can supply the stored touch data to the core circuit 241. Still further, the first PWM generator 245 can operate on in the active mode to generate a PWM signal, and can generate a PWM signal based on a touch synchronization signal (Tsync). The first PWM generator 245 can also generate a PWM signal for each touch frame in the active mode and supply the signal to the touch driver 220 and the touch power supply unit 610.

In addition, the IRQ detection unit 246 can operate on in the active mode to receive an interrupt signal and complete the reception of touch data. For example, the IRQ detection unit 246 can receive a Slave Select signal (SSN) of a Master In-Slave Out signal (MISO) to complete the reception of touch data.

Further, the timing controller 500 can supply a touch synchronization signal (Tsync) to the microcontroller 240 and the touch driver 220. A low-level of the touch synchronization signal (Tsync) can correspond to a touch frame. For example, as is shown in FIG. 5, touch sensing of a first frame (Frame1) can proceed while the touch synchronization signal (Tsync) is at a low-level.

In addition, the touch power supply 610 can receive a PWM signal, generate a common voltage (VCOM), and supply the common voltage (VCOM) to the touch driver 220. The common voltage (VCOM) can have a high-level voltage synchronized with the high-level of the PWM signal and can have a low-level voltage synchronized with the low-level of the PWM signal.

The touch driver 220 can include a second PWM generator 225, which can be operationally OFF in the active mode. In operation, the touch driver 220 can receive the common voltage (VCOM) from the touch power supply unit 610 and supply it to the display panel (100). The touch driver unit (touch driver) 220 can also sequentially supply the common voltage (VCOM) to each of the first to second n-th channel multiplexers CMX1, CMX2, . . . , and CMX(2n) in the active mode. Accordingly, the touch driver 220 can determine the user's touch position by determining the channel multiplexer CMX where the user's touch is sensed in the active mode.

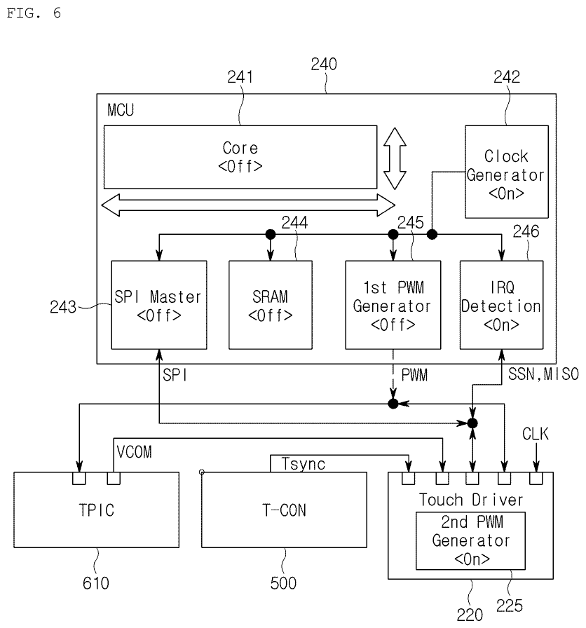

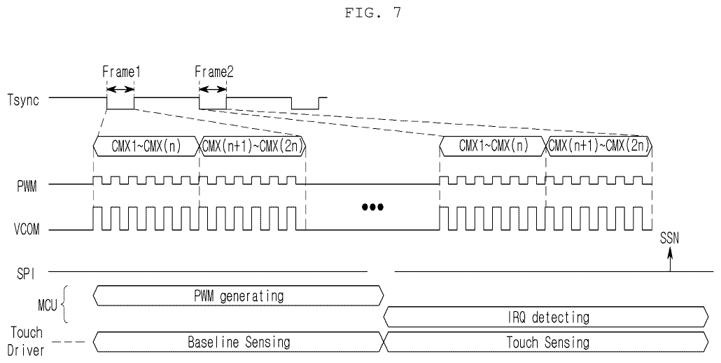

Next, FIG. 6 is a block diagram showing the operation of a microcontroller MCU and a touch driver in an idle mode in a display device according to one embodiment, and FIG. 7 is a waveform view showing a PWM signal and the operation of a microcontroller and a touch driver in an idle mode in a display device according to one embodiment. In the example, the block diagram of FIG. 6 can correspond to operation after a second frame (Frame2).

While the exemplary idle mode can be a state where all activity, e.g., read and write operations, is stopped, in various other embodiments, an idle mode can also encompass a state where a microcontroller and/or other devices operate at a reduced system clock frequency. For instance, in the example of FIG. 6, the microcontroller 240, SPI master 243, and first PWM generator 245 can be operating at 1/100th or 1/1000th the clock speed of an active mode. When CMOS circuitry is used for the microprocessor 240 and/or other components, power consumption is still greatly reduced given power consumption is a function of frequency for CMOS. However, because the system clock speed of the core 241 and other component is not zero, it is possible to substitute the SRAM 244 with dynamic RAM (DRAM), which requires fewer transistors than SRAM. Accordingly, the microcontroller 240 may be fabricated at a reduced cost while still benefitting from reduced power consumption. In still other embodiments an idle mode can be a mode where a system clock frequency remains unchanged, but the number of operations performed is stopped or reduced as compared to an active mode. Overall, an idle mode can be defined as when a component operates at a lower speed as compared to an active mode whether due to a change in a system clock (stopped or slowed) or other means (e.g., circuits logically disabled) so long as power consumption is reduced.

Referring to FIG. 6, the microcontroller 240 can include a core circuit 241, a clock generator 242, an SPI master 243, an SRAM 244, a first PWM generator 245, and an IRQ detection 246. Referring to FIGS. 6 and 7, the microcontroller 240 can control the touch sensing operation of the touch driver 220.

The core circuit 241 can be operationally OFF (i.e., does not operate) in the idle mode, and the core circuit 241 may not perform an operation for determining a touch position. Also, the clock generator circuit 242 can operate ON (i.e., does operate) in the idle mode to generate a clock signal, and can supply the clock signal to the SPI master 243, the SRAM 244, the first PWM generator 245, and the IRQ detection unit 246. The SPI master 243 and the SRAM 244 can also operate OFF in the idle mode.

In addition, the first PWM generator 245 can be operationally ON in the first frame (Frame1) of the idle mode to generate a PWM signal, and can be operationally OFF from the second frame (Frame2) onwards to not generate a PWM signal. Further, the second PWM generator 225 of the touch driver 220 can be operationally ON from the second frame (Frame2) onwards to generate a PWM signal, and can perform counting operations on the PWM signal received from the first PWM generator 245 using the internal clock signal (CLK). Accordingly, the second PWM generator 225 can determine a high pulse width, a low pulse width, a pulse count, and initial interval information of the PWM signal generated in the first frame (Frame1) and store them in a register. Then, the second PWM generator 225 can generate a PWM signal from the second frame (Frame2) onwards based on the stored high pulse width, low pulse width, pulse count, and initial interval information.

Further, the touch power supply unit 610 can generate a common voltage (VCOM) based on the PWM signal, and supply the common voltage (VCOM) to the touch driver 220. The touch power supply unit 610 can also generate a common voltage (VCOM) based on the PWM signal of the first PWM generator 245 in the first frame (Frame1) of the idle mode, and can generate a common voltage (VCOM) based on the PWM signal of the second PWM generator 225 from the second frame (Frame2) of the idle mode. The common voltage (VCOM) can have a high-level voltage in synchronization with the high-level of the PWM signal, and can have a low-level voltage in synchronization with the low-level of the PWM signal.

In addition, the IRQ detection unit 246 can be operationally OFF in the first frame (Frame1) of the idle mode, and can be operationally ON from the second frame (Frame2) of the idle mode. In operation, the IRQ detection unit 246 can detect an interrupt request (IRQ detecting) from the second frame (Frame2) of the idle mode, receive an interrupt signal, and complete the reception of touch data. In various examples, the IRQ detection unit 246 can complete the reception of touch data by receiving an SSN (Slave Select) signal or a MISO (Master In-Slave Out).

The timing controller 500 can supply a touch synchronization signal (Tsync) to the touch driver 220 with a low-level of the touch synchronization signal (Tsync) corresponding to a touch frame. In operation, touch sensing of the first frame (Frame1) can proceed at the first low-level of the touch synchronization signal (Tsync), and touch sensing of the second frame (Frame2) can proceed at the second low-level of the touch synchronization signal (Tsync).

In addition, the touch driver 220 can receive a common voltage (VCOM) from the touch power supply unit 610 and supply the common voltage (VCOM) to the display panel 100. The touch driver 220 can also determine whether a user's touch occurs by merging a plurality of channel multiplexers CMX into at least one group in the idle mode. As mentioned above, the plurality of channel multiplexers CMX can be merged into one group by being shorted. For example, the touch driver 220 can merge the first to nth channel multiplexers CMX1, CMX2, . . . , and CMX(n) in the idle mode and supply the common voltage VCOM to the first to nth channel multiplexers CMX1, CMX2, . . . , and CMX(n) simultaneously. Thus, the touch driver 220 can simultaneously supply a common voltage (VCOM) to the n+1 to 2n channel multiplexers CMX(n+1), CMX(n+2), . . . , and CMX(2n) by merging the n+1 to 2n channel multiplexers CMX(n+1), CMX(n+2), . . . , and CMX(2n) in the idle mode.

In addition, the touch driver 220 can set a baseline based on the touch sensing signal of the first frame (Frame1) and determine whether a user's touch has occurred based on the touch sensing signal of the second frame (Frame2). The touch driver 220 can then determine whether a user's touch has occurred if the touch sensing signal of the second frame (Frame2) has a significant difference from the baseline.

In operation, the display device 10 can reduce power consumption and extend the life of the microcontroller 240 by turning off (or substantially reducing) the operation of the core circuit 241, SPI master 243, SRAM 244, and first PWM generator 245 of the microcontroller 240 in idle mode. Because a part of the microcontroller 240 does not operate in idle mode, the operation of the microcontroller 240 can still be performed smoothly.

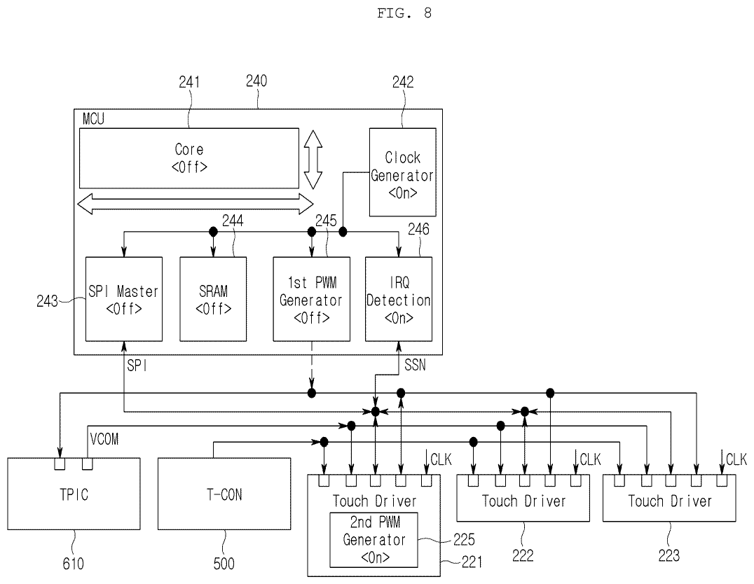

Next, FIG. 8 is a block diagram showing the operation of a microcontroller and a touch driver in an idle mode in a display device according to another embodiment. The display device of FIG. 8 includes a plurality of touch driver circuits similar to the touch driver 220 of FIG. 6, and the same configuration as the above-described configuration will be briefly described or omitted. Referring to FIG. 8, the touch driver 220 can include first to third touch drivers (circuits) 221, 222, and 223. Each of the first to third touch driver circuits 221, 222, and 223 can receive a common voltage (VCOM) from the touch power supply unit 610 and supply the common voltage (VCOM) to the display panel 100. The touch driver 220 can determine whether a user's touch occurs by merging a plurality of channel multiplexers CMX into at least one group in the idle mode by being shorted.

In addition, the first touch driver 221 may include a second PWM generator 225, which can be turned on and generate a PWM signal after the second frame (Frame2) of the idle mode. The second PWM generator 225 of the first touch driver 221 can perform counting operations on a PWM signal received from the first PWM generator 245 using an internal clock signal CLK. Specifically, the second PWM generator 225 can count and store in a register a high pulse width, a low pulse width, a pulse count, and initial interval information of the PWM signal generated in the first frame (Frame1). Subsequently, the second PWM generator 225 can generate a PWM signal after the second frame (Frame2) based on the stored high pulse width, low pulse width, pulse count, and initial interval information.

Also, the touch power supply unit 610 can generate a common voltage (VCOM) based on a PWM signal, and supply the common voltage (VCOM) to the first to third touch driver 221, 222, and 223. The touch power supply unit 610 can generate the common voltage (VCOM) based on the PWM signal of the first PWM generator 245 in the first frame (Frame1) of the idle mode, and can generate the common voltage (VCOM) based on the PWM signal of the second PWM generator 225 from the second frame (Frame2) of the idle mode onwards. The common voltage (VCOM) can have a high-level voltage in synchronization with the high-level of the PWM signal, and can have a low-level voltage in synchronization with the low-level of the PWM signal. Accordingly, the common voltage (VCOM) can be generated based on the PWM signal of the second PWM generator 225 of the first touch driver 221 and may be commonly supplied to the first to third touch drivers 221, 222, and 223.

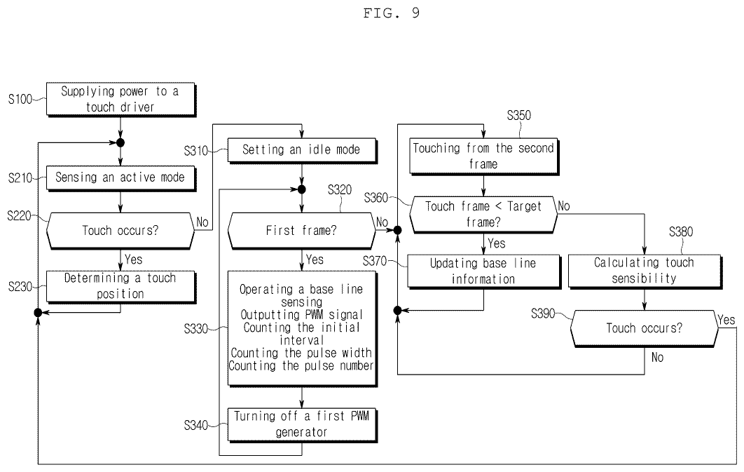

Next, FIG. 9 is a flowchart showing a touch sensing process in a display device according to one embodiment. Referring to FIG. 9, operation starts with the touch power supply 610 supplying a common voltage (VCOM) to the touch driver 220 (step S100) where the touch driver 220 can sense a user's touch in an active mode (step S210).

Next, a determination is made as to whether a user's touch occurs (step S220). If a user's touch occurs, the touch driver 220 can determine a user's touch location (step S230). As stated above, the touch driver 220 can determine a channel multiplexer CMX where the user's touch is sensed by sequentially supplying a common voltage (VCOM) to each of the first to second n-th channel multiplexers CMX1, CMX2, . . . , and CMX(2n) in the active mode.

However, if a user's touch does not occur (step S220), the microcontroller 240 and the touch driver 220 can be set to an idle mode (step S310). Next, the first PWM generator 245 of the microcontroller 240 can output a PWM signal by operating on in the first frame (Frame1) of the idle mode (step S330). As stated above, the second PWM generator 225 of the touch driver 220 can perform counting operations on the PWM signal received from the first PWM generator 245 using the internal clock signal (CLK) so that the second PWM generator 225 can count the high pulse width, the low pulse width, the pulse count, and initial interval information of the PWM signal generated in the first frame (Frame1) and store these values in a register (step S330). The touch driver 220 can also set a baseline based on the touch sensing signal of the first frame (Frame1) (step S330).

Next, the first PWM generator 245 can operate in an OFF mode after the second frame (Frame2) and not generate a PWM signal (step S340). Also, the second PWM generator 225 of the touch driver 220 can operate in an ON mode after the second frame (Frame2) of the idle mode and generate a PWM signal (step S350). The second PWM generator 225 can generate a PWM signal after the second frame (Frame2) based on the stored high pulse width, low pulse width, pulse number, and initial interval information.

Next, a determination is made as to whether the touch frame has not reached a target frame (step S360). Here, the target frame can correspond to the number of frames for setting the baseline. If the touch frame has not reached the target frame (step S360), the touch driver 220 can update the baseline information (step S370). The touch driver 220 can repeat the update until the touch frame reaches the target frame.

If the touch frame has reached the target frame (step S360), the touch driver 220 can calculate the touch sensitivity (step S380). The touch driver 220 can then compare the touch sensing signal with the baseline when the user's touch occurs (step S390) and determine the occurrence of the user's touch when the touch sensing signal has a significant difference from the baseline. In contrast, the touch driver 220 can determine the user's touch did not occur when the touch sensing signal does not have a significant difference from the baseline. The touch driver 220 can compare the touch sensing signal with the baseline until the user's touch occurs. The touch driver 220 and the microcontroller 240 can then switch to the active mode (step S210) when the user's touch occurs and determines the user's touch location.

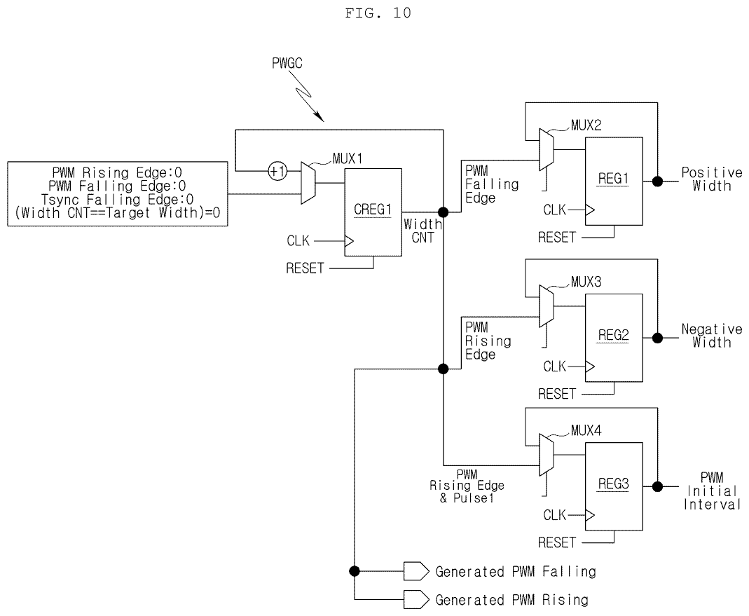

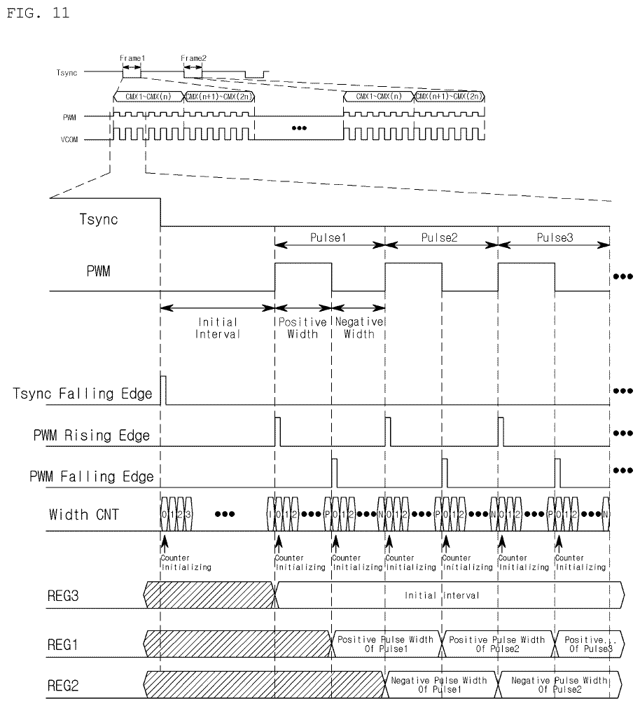

Next, FIG. 10 is a view showing a pulse width generation of a second PWM generator in a display device according to one embodiment, and FIG. 11 is a waveform diagram showing the operation of a pulse width generation of a second PWM generator in a display device according to one embodiment. Referring to FIGS. 10 and 11, the second PWM generator 225 of the touch driver 220 may include a pulse width generation PWGC. The pulse width generation (PWGC) of the second PWM generator 225 can count and store in a register the high pulse width (Positive Width), low pulse width (Negative Width), and initial interval information of the PWM signal generated by the first PWM generator 245 in the first frame (Frame1). The pulse width generation PWGC can also include first to fourth multiplexers MUX1, MUX2, MUX3, and MUX4, a first counter CREG1, and first to third registers REG1, REG2, and REG3.

In operation, the first input terminal of the first multiplexer MUX1 can receive a 0 value at the rising edge of the PWM signal (PWM Rising Edge:0), a 0 value at the falling edge of the PWM signal (PWM Falling Edge:0), a 0 value at the falling edge of the touch synchronization signal (Tsync) (Tsync Falling Edge:0), and a 0 value when the count value reaches the target width (Width CNT==Target Width:0). When the condition of the first input terminal is satisfied, the first multiplexer MUX1 can supply the input value of the first input terminal to the first counter CREG1. When the condition of the first input terminal is not satisfied, the second input terminal of the first multiplexer MUX1 can receive a value obtained by adding 1 (+1) or a count to the output value of the first counter CREG1, and output the corresponding count value to the first counter CREG1.

The first counter CREG1 can receive an output value of the first multiplexer MUX1, a clock signal CLK, and a reset signal RESET, then perform a count based on the clock signal CLK, and store and output a count value (Width CNT). Next, the count value (Width CNT) of the first counter CREG1 can be supplied to each input terminal of the first to fourth multiplexers MUX1, MUX2, MUX3, and MUX4. Accordingly, the second PWM generator 225 can count the high pulse width (Positive Width), low pulse width (Negative Width), and initial interval (Initial Interval) information of the PWM signal generated by the first PWM generator 245 using a first counter CREG1 of the pulse width generation PWGC, and store the corresponding count values (Width CNT) in each of the first to third registers REG1, REG2, and REG3.

Next, the first input terminal of the second multiplexer MUX2 can receive the count value (Width CNT) from a time after the occurrence of the rising edge (PWM Rising Edge) of the PWM signal until a time of the occurrence of the falling edge (PWM Falling Edge) of the PWM signal. This count value (Width CNT) can correspond to a high pulse width (Positive Width) of the PWM signal. During operation, the count value (Width CNT) can be initialized (Counter Initializing) at the rising edge (PWM Rising Edge) of the PWM signal, and the first counter (CREG1) can perform counting until a falling edge (PWM Falling Edge) of the PWM signal occurs. For example, the first counter CREG1 can output a count value (Width CNT) increased by 1 from 0 to P (P is a positive integer). Here, P can correspond to the count value (Width CNT) at the time when the falling edge (PWM Falling Edge) of the PWM signal occurs. Therefore, the first input terminal of the second multiplexer MUX2 can receive the count value (Width CNT) corresponding to the high pulse width (Positive Width) of the PWM signal and supply it to the first register REG1.

In addition, the second input terminal of the second multiplexer MUX2 can receive the output value of the first register REG1 when the condition of the first input terminal is not met. The second input terminal of the second multiplexer MUX2 can then supply the output value of the first register REG1 to the first register REG1.

Accordingly, the first register REG1 can store and output the count value (Width CNT) corresponding to the high pulse width (Positive Width) of the first pulse (Pulse1) after the occurrence of the falling edge (PWM Falling edge) of the first pulse (Pulse1). Next, the first register REG1 can store and output a count value (Width CNT) corresponding to the high pulse width (Positive Width) of the second pulse (Pulse2) after the falling edge (PWM Falling edge) of the second pulse (Pulse2) occurs. Also, the first register REG1 can store and output a count value (Width CNT) corresponding to the high pulse width (Positive Width) of the third pulse (Pulse3) after the falling edge (PWM Falling edge) of the third pulse (Pulse3) occurs. Next, the pulse width generation PWGC can output a falling signal (Generated PWM Falling) of a PWM signal at the moment when the first counter CREG1 counts the count value (Width CNT) corresponding to the high pulse width (Positive Width) after the second frame (Frame2).

In addition, the first input terminal of the third multiplexer MUX3 can receive a count value (Width CNT) from after the occurrence of the falling edge (PWM Falling Edge) of the PWM signal until the occurrence of the rising edge (PWM Rising Edge) of the PWM signal. The count value (Width CNT) from after the occurrence of the falling edge (PWM Falling Edge) of the PWM signal until the occurrence of the rising edge (PWM Rising Edge) of the PWM signal can correspond to the low pulse width (Negative Width) of the PWM signal. The count value (Width CNT) can be initialized at the occurrence of the falling edge (PWM Falling Edge) of the PWM signal (Counter Initializing), and the first counter CREG1 can perform counting until the occurrence of the rising edge (PWM Rising Edge) of the PWM signal. For example, the first counter CREG1 can output a count value (Width CNT) increased by 1 from 0 to N (N is a positive integer). Here, N can correspond to the count value (Width CNT) at the time when the rising edge (PWM Rising Edge) of the PWM signal occurs. Therefore, the first input terminal of the third multiplexer MUX3 can receive the count value (Width CNT) corresponding to the low pulse width (Negative Width) of the PWM signal and supply it to the second register REG2.

Further, the second input terminal of the third multiplexer MUX3 can receive the output value of the second register REG2 when the condition of the first input terminal is not met, and then once more supply the output value of the second register REG2 to the second register REG2. Therefore, the second register REG2 can store and output the count value (Width CNT) corresponding to the low pulse width (Negative Width) of the first pulse (Pulse1) after the rising edge (PWM Rising Edge) of the second pulse (Pulse2) occurs. In addition, the second register REG2 can store and output the count value (Width CNT) corresponding to the low pulse width (Negative Width) of the first pulse (Pulse1) after the rising edge (PWM Rising Edge) of the third pulse (Pulse3) occurs. At the moment when the first counter CREG1 counts the count value (Width CNT) corresponding to the low pulse width (Negative Width) after the second frame (Frame2), the pulse width generation PWGC can output the rising signal (Generated PWM Rising) of the PWM signal.

Also, the first input terminal of the fourth multiplexer MUX4 can receive a count value (Width CNT) from after the occurrence of the falling edge (Tsync Falling Edge) of the touch synchronization signal until the occurrence of the rising edge (PWM Rising Edge) of the first pulse or the first pulse (Pulse1). The count value (Width CNT) from after the occurrence of the falling edge (Tsync Falling Edge) of the touch synchronization signal until the occurrence of the rising edge (PWM Rising Edge) of the first pulse (Pulse1) can correspond to an initial interval (Initial Interval) of the PWM signal. Similarly, the count value (Width CNT) can be initialized at the falling edge (Tsync Falling Edge) of the touch synchronization signal (Counter Initializing), whereafter the first counter CREG1 can perform counting until the occurrence of the rising edge (PWM Rising Edge) of the first pulse (Pulse1). For example, the first counter CREG1 can output a count value (Width CNT) increased by 1 from 0 to I (I is a positive integer). Here, integer I can correspond to the count value (Width CNT) at the time when the rising edge (PWM Rising Edge) of the first pulse (Pulse1) occurs. Accordingly, the first input terminal of the fourth multiplexer MUX4 can receive the count value (Width CNT) corresponding to the initial interval of the PWM signal and supply it to the third register REG3.

In addition, the second input terminal of the fourth multiplexer MUX2 can receive the output value of the third register REG3 when the condition of the first input terminal is not met. The second input terminal of the fourth multiplexer MUX2 can then supply the output value of the third register REG3 to the third register REG3 again.

Therefore, the third register REG3 can store and output the count value (Width CNT) corresponding to the initial interval (Initial Interval) of the PWM signal after the rising edge (PWM Rising Edge) of the first pulse (Pulse1) occurs. The pulse width generation PWGC can then output the rising signal (Generated PWM Rising) of the PWM signal at the moment when the first counter CREG1 counts the count value (Width CNT) corresponding to the initial interval (Initial Interval) of the PWM signal after the second frame (Frame2).

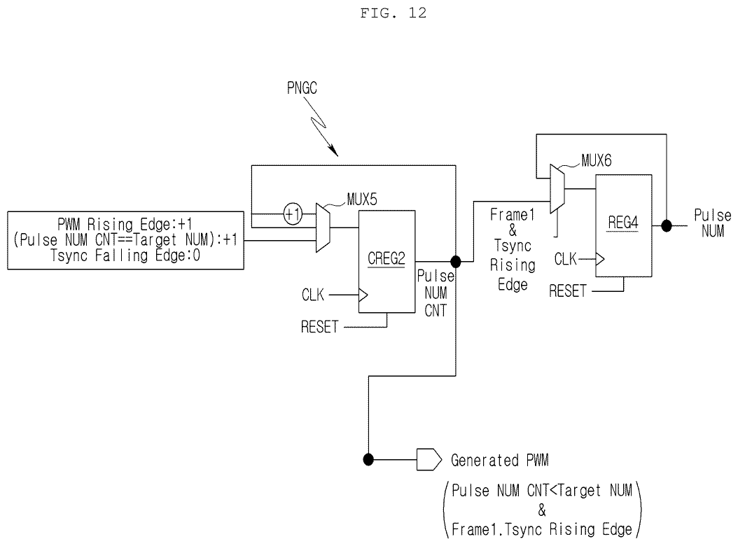

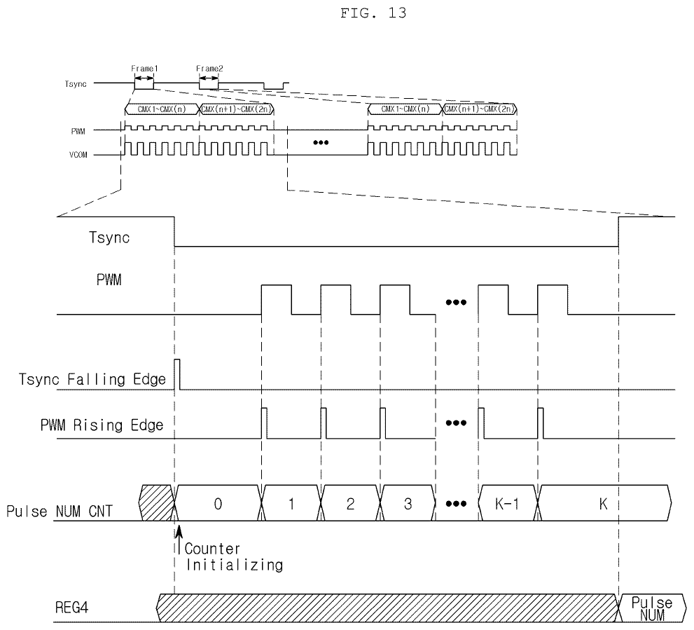

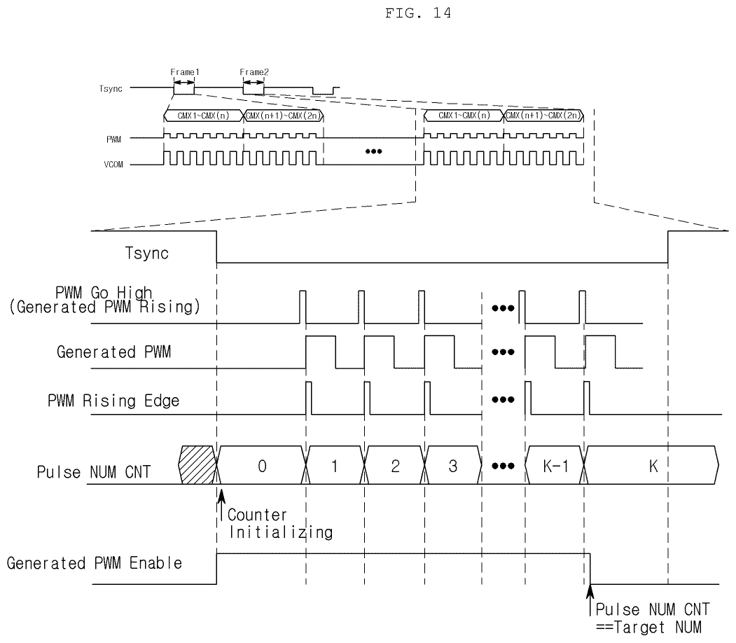

Next, FIG. 12 is a view showing a pulse number generation PNGC of a second PWM generator in a display device according to one embodiment. FIG. 13 is a waveform diagram showing the operation of a pulse number generation of a second PWM generator in a first frame in a display device according to one embodiment. FIG. 14 is a waveform view showing the operation of a pulse number generation of a second PWM generator in a second frame in a display device according to one embodiment.

Referring to FIGS. 12 to 14, the second PWM generator 225 of the touch driver 220 can include a pulse number generation PNGC. The pulse number generation PNGC of the second PWM generator 225 can count the pulse number (Pulse NUM) of the PWM signal generated by the first PWM generator 245 in the first frame (Frame1) and store it in the fourth register REG4. The pulse width generation PWGC can include the fifth and sixth multiplexers, MUX5 and MUX6, the second counter CREG2, and the fourth register REG4. In operation, the first input terminal of the fifth multiplexer MUX5 can receive a 0 value at the falling edge of the touch synchronization signal (Tsync) (Tsync Falling Edge: 0), can receive a value obtained by adding 1 (+1) or adding a count at each rising edge (PWM Rising Edge) of the PWM signal, and can output the corresponding count value to the second counter CREG2.

Next, the second counter CREG2 can receive the output value of the fifth multiplexer MUX5, a clock signal CLK, and a reset signal RESET. The second counter CREG2 can then perform a count based on the clock signal CLK, and can store and output a count value (Pulse NUM CNT). The count value (Width CNT) of the second counter CREG2 can be supplied to the input terminal of the sixth multiplexer MUX6. Accordingly, the second PWM generator 225 may count the pulse number (Pulse NUM) of the PWM signal generated by the first PWM generator 245 using the second counter CREG2 of the pulse width generation PWGC, and store the corresponding count value (Pulse NUM CNT) in the fourth register REG4.

During operation, the first input terminal of the sixth multiplexer MUX6 can receive the count value (Pulse NUM CNT) from the occurrence of the falling edge (Tsync Falling Edge) of the touch synchronization signal in the first frame (Frame1) until the occurrence of the rising edge (Tsync Rising Edge) of the touch synchronization signal with this count value (Pulse NUM CNT) corresponds to the pulse number (Pulse NUM) of the PWM signal. The count value (Pulse NUM CNT) can be initialized at the falling edge (Tsync Falling Edge) of the touch sync signal (Counter Initializing), and can add 1 (+1) or add a count at each rising edge (PWM Rising Edge) of the PWM signal. For example, the second counter CREG2 can output a count value (Pulse NUM CNT) increased by 1 from 0 to K (K is a positive integer). Here, K can correspond to the count value (Pulse NUM CNT) at the time when the rising edge (Tsync Rising Edge) of the touch sync signal occurs in the first frame (Frame1). Accordingly, the first input terminal of the sixth multiplexer MUX6 can receive the count value (Pulse NUM CNT) corresponding to the pulse number (Pulse NUM) of the PWM signal and supply the pulse number (Pulse NUM) of the PWM to the fourth register REG4. Next, the second input terminal of the sixth multiplexer MUX6 can receive the output value of the fourth register REG4 if the condition of the first input terminal is not met, and again supply the output value of the fourth register REG4 to the fourth register REG4.

As is shown in FIG. 13, the fourth register REG4 can store and output a count value (Pulse NUM CNT) corresponding to the pulse number (Pulse NUM) of the PWM signal after the rising edge (Tsync Rising Edge) of the touch synchronization signal occurs in the first frame (Frame1). As is shown in FIG. 14, the pulse number generation PNGC of the second PWM generator 225 can generate a PWM enable signal (PWM Enable) based on the count value (Pulse NUM CNT) stored in the first frame (Frame1) in the second frame (Frame2). The PWM enable signal (PWM Enable) can be generated based on the count value (Pulse NUM CNT) of the second counter CREG2, and can maintain a high-level from a point in time after the falling edge (Tsync Falling Edge) of the touch synchronization signal occurs in the second frame (Frame2) until the count value (Pulse NUM CNT) reaches the target value (Target NUM). Here, the target value (Target NUM) can correspond to the pulse number (Pulse NUM) of the PWM signal stored in the fourth register REG4. In connection with FIG. 13, the target value (Target NUM) can correspond to K, the second counter CREG2 can count from 0 to K, and the second PWM generator 225 can generate a PWM signal having a pulse number (Pulse NUM) of K.

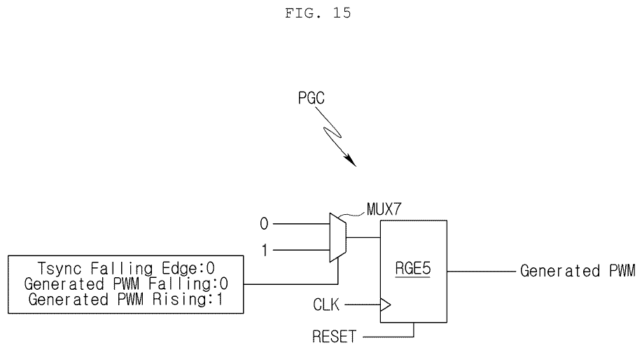

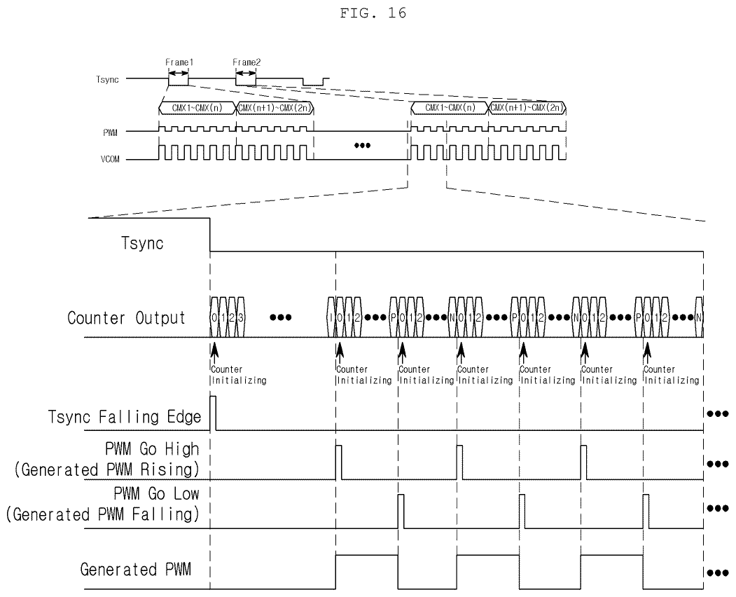

Next, FIG. 15 is a view showing a pulse generation of a second PWM generator in a display device according to one embodiment. FIG. 16 is a waveform diagram showing the operation of a pulse generation of a second PWM generator in a display device according to this embodiment. Referring to FIGS. 15 and 16, the second PWM generator 225 of the touch driver 220 can include a pulse generation PGC, and the pulse generation PGC can include a seventh multiplexer MUX7 and a fifth register REG5. In operation, the pulse generation PGC can receive a rising signal of a PWM signal (Generated PWM Rising) and a falling signal of a PWM signal (Generated PWM Falling) from the pulse width generation PWGC. The pulse generation PGC can then generate a PWM signal based on a high pulse width (Positive Width), a low pulse width (Negative Width), an initial interval (Initial Interval) generated by the pulse width generation PWGC, and a pulse number (Pulse NUM) generated by the pulse number generation PNGC.

Combined with the circuitry described with respect to FIGS. 10 and 11, the pulse width generation PWGC of FIG. 15 can output a rising signal (Generated PWM Rising) of a PWM signal at the moment when the first counter CREG1 counts a count value (Width CNT) corresponding to an initial interval (Initial Interval) of a PWM signal after the second frame (Frame2), and can output a rising signal (Generated PWM Rising) of a PWM signal at the moment when the first counter CREG1 counts an I value corresponding to an initial interval (Initial Interval) of a PWM signal. Similarly, the pulse width generation PWGC can output a falling signal (Generated PWM Falling) of a PWM signal at the moment when the first counter CREG1 counts a count value (Width CNT) corresponding to a high pulse width (Positive Width) after the second frame (Frame2), and can output a falling signal (Generated PWM Falling) of a PWM signal at the moment when the first counter CREG1 counts a P value corresponding to a high pulse width (Positive Width). In addition, the pulse width generation PWGC can output a rising signal (Generated PWM Rising) of a PWM signal at the moment when the first counter CREG1 counts a count value (Width CNT) corresponding to a low pulse width (Negative Width) after the second frame (Frame2), and can output a rising signal (Generated PWM Rising) of a PWM signal at the moment when the first counter CREG1 counts an N value corresponding to a low pulse width (Negative Width).

The seventh MUX7 can receive a 0 value at the falling edge of the touch synchronization signal (Tsync) (Tsync Falling Edge: 0), a 0 value at the falling signal of the PWM signal (Generated PWM Falling), and a 1 value at the rising signal of the PWM signal (Generated PWM Rising). The seventh MUX7 can then output one of the received values of 0 and 1 to the fifth register REG5.

The fifth register REG5 can receive the output value of the seventh MUX7, a clock signal (CLK), and a reset signal (RESET). When the fifth register REG5 receives a 0 value from the seventh MUX7, the fifth register REG5 can generate a low-level of the PWM signal. When the fifth register REG5 receives a 1 value from the seventh MUX7, the fifth register REG5 can generate a high-level of the PWM signal. The second PWM generator 225 can generate the high-level and the low-level of the PWM signal output from the fifth register REG5 as many times as indicates by the pulse number (Pulse NUM) of the PWM signal. The generated PWM signal (Generated PWM) can then be used to determine whether a user touches the screen in the idle mode. Therefore, the display device 10 can reduce power consumption and extend the life of the microcontroller 240 by turning off the operation of the core 241, SPI master 243, SRAM 244, and first PWM generator 245 of the microcontroller 240 in the idle mode. In addition, since a part of the microcontroller 240 does not operate in the idle mode, the operation of the microcontroller 240 can be performed smoothly.

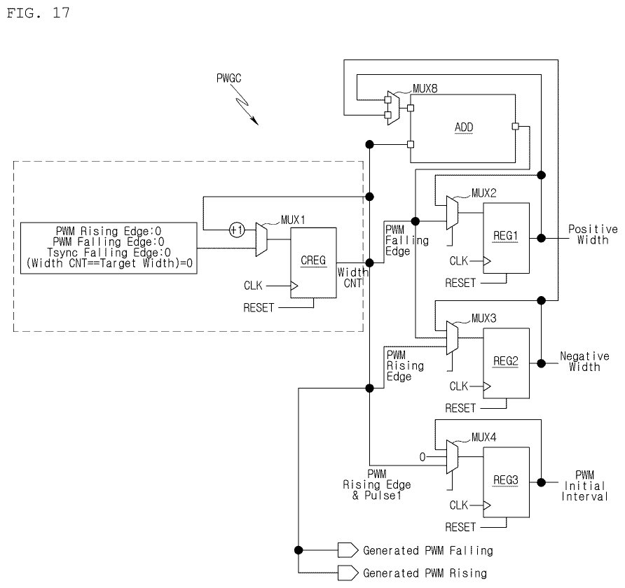

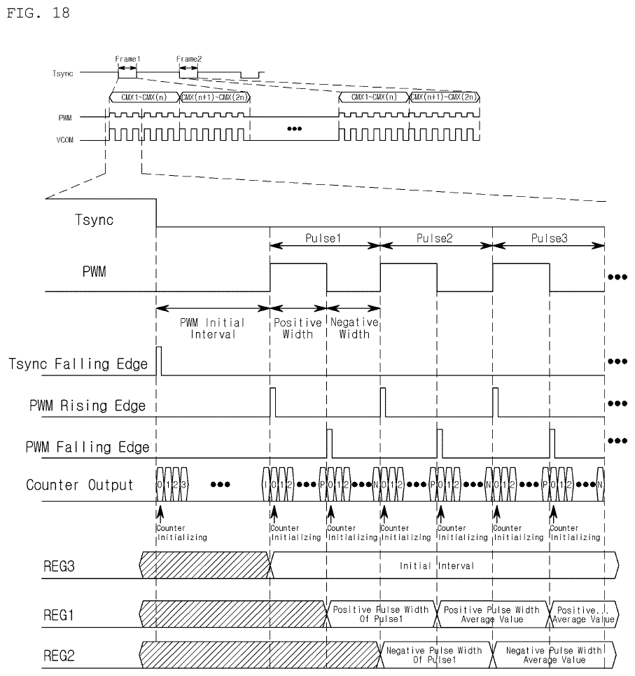

Next, FIG. 17 is a diagram showing a pulse width generation of a second PWM generator in a display device according to another embodiment, and FIG. 18 is a waveform view showing the operation of the pulse width generation of the second PWM generator according to this embodiment. The pulse width generation PWGC of FIG. 17 is similar to the pulse width generation PWGC of FIG. 10, but further includes an average generator ADD. Given the similar design of FIG. 17 to FIG. 10, aspects of the above-described configuration of FIG. 10 will be briefly described or omitted.

Referring to FIGS. 17 and 18, the second PWM generator 225 of the touch driver 220 can include a pulse width generation PWGC. The pulse width generation PWGC of the second PWM generator 225 can count and store in a register the high pulse width (Positive Width), low pulse width (Negative Width), and initial interval information of the PWM signal generated by the first PWM generator 245 in the first frame (Frame1). The pulse width generation PWGC can also include first to fourth and eighth multiplexers (MUX1, MUX2, MUX3, MUX4, and MUX8, a first counter CREG1, first to third registers REG1, REG2, and REG3, and an average generator ADD.

A first input terminal of the eighth multiplexer (MUX8) can be connected to an output terminal of the first register (REG1) to receive a high pulse width (Positive Width) of a PWM signal. A second input terminal of the eighth multiplexer (MUX8) can be connected to an output terminal of the second register (REG2) to receive a low pulse width (Negative Width) of the PWM signal. In operation, the eighth multiplexer (MUX8) can supply a high pulse width (Positive Width) or a low pulse width (Negative Width) of the PWM signal to the average generator (ADD).

The average generator ADD, in turn, can calculate the average of the high pulse width (Positive Width) of the PWM signal and supply the average of the high pulse width (Positive Width) of the PWM signal to the second multiplexer MUX2. In turn, the second multiplexer MUX2 can supply the average value of the high pulse width (Positive Width) to the first register REG1 whereafter the first register REG1 can store and output a count value (Width CNT) corresponding to the average of the high pulse width (Positive Width). The average generator ADD can also calculate the average of the low pulse width (Negative Width) of the PWM signal and supply the average of the low pulse width (Negative Width) of the PWM signal to the third multiplexer MUX3. In turn, the third multiplexer MUX3 can supply the average value of the low pulse width (Negative Width) to the second register REG2 whereafter the second register REG2 can store and output a count value (Width CNT) corresponding to the average of the low pulse width (Negative Width). The average generator ADD can also calculate the average of the high pulse width (Positive Width) of the previous pulse and the high pulse width (Positive Width) of the corresponding pulse. For example, the average generator ADD can calculate the average of the high pulse widths (Positive Width) of the first and second pulses (Pulse1, Pulse2) and supply the average of the high pulse widths (Positive Width) of the first and second pulses to the second multiplexer MUX2. In addition, the first register REG1 can store and output a count value (Width CNT) corresponding to the average of the high pulse widths (Positive Width) of the first and second pulses (Pulse1, Pulse2) after the occurrence of the falling edge (PWM Falling edge) of the second pulse (Pulse2).

Still further, the average generator ADD can calculate the average of the high pulse widths (Positive Width) of the first to third pulses (Pulse1, Pulse2, Pulse3) and supply the average to the second multiplexer MUX2. In addition, the first register REG1 can store and output a count value (Width CNT) corresponding to the average of the high pulse widths (Positive Width) of the first to third pulses (Pulse1, Pulse2, and Pulse3) after the occurrence of the falling edge (PWM Falling edge) of the third pulse (Pulse3). The average generator ADD can further calculate the average of the high pulse width (Positive Width) of the previous pulse and the low pulse width (Negative Width) of the corresponding pulse. For example, the average estimator ADD can calculate the average of the low pulse widths (Negative Width) of the first and second pulses (Pulse1, Pulse2) and supply the average to the third multiplexer MUX3. In addition, the second register REG2 can store and output a count value (Width CNT) corresponding to the average of the low pulse widths (Negative Width) of the first and second pulses (Pulse1, Pulse2) after the occurrence of the rising edge (PWM Rising edge) of the third pulse (Pulse3).

The display device according to various embodiments of the present specification can be described as follows. The display device according to the various embodiments of the present disclosure can include a microcontroller including a core configured to operate in an active mode to perform an operation for determining a user's touch position, and a first PWM generator configured to generate a PWM signal in the active mode; a touch driver comprising a second PWM generator configured to generate a PWM signal based on a high pulse width, a low pulse width, a pulse count, and initial interval information of a PWM signal generated by the first PWM generator in an idle mode for determining whether a user's touch has occurred; a timing controller configured to generate a touch synchronization signal supplied to the microcontroller and the touch driver; and a plurality of touch electrodes configured to receive a common voltage generated based on the PWM signal and driven in the active mode or the idle mode.

In operation, the display device according to the various embodiments, the first PWM generator can operate according to an ON mode in a first frame of the idle mode and in an OFF mode in a second frame of the idle mode. In the display device, the microcontroller can further include an SPI master configured to perform bidirectional data communication between peripheral devices using an SPI signal; an SRAM configured to store touch data included in the SPI signal; and an IRQ detection configured to receive an interrupt signal and completes reception of the touch data. Also, the SPI master and the SRAM can operate in an ON mode in the active mode and in an OFF mode in the idle mode, while the IRQ detection can operate in an ON mode in both the active mode and the idle mode.

In addition, the second PWM generator can count the high pulse width, low pulse width, pulse number, and initial interval information of the PWM signal generated by the first PWM generator during the first frame of the idle mode, and generate a PWM signal based on the count values of the high pulse width, low pulse width, and initial interval information of the PWM signal from the second frame onwards of the idle mode. Further, the second PWM generator can include a pulse width generation configured to count the high pulse width, the low pulse width, and the initial interval information of the PWM signal and outputs the rising signal of the PWM signal and the falling signal of the PWM signal; a pulse number generation configured to count and store the pulse number of the PWM signal; and a pulse generation configured to generate the PWM signal based on the rising signal of the PWM signal, the falling signal of the PWM signal, and the pulse number of the PWM signal.

Still further, the pulse width generation can include a first multiplexer configured to receive a 0 value at the rising edge of the PWM signal, the falling edge of the PWM signal, and the falling edge of the touch synchronization signal, and output a count value by adding a count. The pulse width generation can also include a first counter configured to store and outputs a count value of the first multiplexer, a second multiplexer is configured to receive a count value from after the rising edge of the PWM signal occurs until the falling edge of the PWM signal occurs, and a first register configured to store and outputs a count value corresponding to the high pulse width of the PWM signal based on the count value of the second multiplexer. In addition, a third multiplexer is configured to receive a count value from after a time the falling edge of the PWM signal occurs until a time the rising edge of the PWM signal occurs, and a second register is configured to store and output a count value corresponding to the low pulse width of the PWM signal based on the count value of the third multiplexer, Also, a fourth multiplexer is configured to receive a count value from a time after the falling edge of the touch synchronization signal occurs until a time the rising edge of the first pulse occurs with a third register storing and outputting a count value corresponding to the initial interval of the PWM signal based on the count value of the fourth multiplexer. Also, the pulse width generation can output a falling signal of the PWM signal at the moment when the first counter counts a count value corresponding to the high pulse width, can output a rising signal of the PWM signal at the moment when the first counter counts a count value corresponding to the low pulse width, and can output a rising signal of the PWM signal at the moment when the first counter counts a count value corresponding to the initial interval of the PWM signal.

Further, the pulse width generation can include an average generator configured to calculate an average of the high pulse width of the PWM signal and supply the average of the high pulse width to the second multiplexer, and also calculate an average of the low pulse width of the PWM signal and supply the average of the low pulse width to the third multiplexer. Also, the pulse number generation can include a fifth multiplexer configured to receive a 0 value at the falling edge of the touch synchronization signal and outputting a count value by adding a count; a second counter configured to store and outputting a count value of the fifth multiplexer; a sixth multiplexer configured to receive a count value from a time after the falling edge of the touch synchronization signal occurs until a time the rising edge of the touch synchronization signal occurs; and a fourth register configured to store and output a count value corresponding to the number of pulses of the PWM signal based on the count value of the sixth multiplexer. Still further, the pulse number generation can generate a PWM enable signal maintaining a high-level from the time the falling edge of the touch synchronization signal occurs until the count value of the fifth multiplexer reaches the target value based on the count value stored in the fourth register.

In addition, the pulse generation can include a seventh multiplexer configured to receive a 0 value at the falling edge of the touch synchronization signal, a 0 value at the falling edge of the PWM signal, and a 1 value at the rising edge of the PWM signal. Also, a fifth register can generate a low-level of the PWM signal when receiving a 0 value from the seventh multiplexer, and generate a high-level of the PWM signal when receiving a 1 value from the seventh multiplexer.

In the display device according to the various embodiments, the touch driver can include a first touch driver and a second touch driver circuit. The first touch driver can be configured to generate a PWM signal based on a PWM signal generated by the first PWM generator circuit, and can include a PWM generator circuit. The second touch driver can be configured to receive a common voltage generated based on the PWM signal generated by the first touch driver circuit, can sequentially supply a common voltage to each of the plurality of channel multiplexers connected to the plurality of touch electrodes in the active mode, and can simultaneously supply a common voltage by merging the plurality of channel multiplexers into one group in the idle mode.

In another aspect, the display device according to the various embodiments can include a microcontroller including a first PWM generator configured to generate a PWM signal in an active mode for determining a user's touch position; a touch driver including a second PWM generator configured to generate a PWM signal based on a high pulse width, a low pulse width, a pulse count, and initial interval information of a PWM signal generated by the first PWM generator in an idle mode for determining whether a user's touch occurs; and a plurality of touch electrodes configured to receive a common voltage generated based on the PWM signal to be driven in the active mode or the idle mode. The first PWM generator can operate on in the first frame of the idle mode and off from the second frame onwards of the idle mode. The second PWM generator can count the high pulse width, low pulse width, pulse number, and initial interval information of the PWM signal generated by the first PWM generator during the first frame of the idle mode, and generate a PWM signal based on the count values of the high pulse width, low pulse width, and initial interval information of the PWM signal from the second frame onwards of the idle mode.

In the display device according to the various embodiments, the second PWM generator can include a pulse width generation configured to count the high pulse width, the low pulse width, and the initial interval information of the PWM signal and outputs the rising signal of the PWM signal and the falling signal of the PWM signal; a pulse number generation configured to count and store the pulse number of the PWM signal; and a pulse generation configured to generate the PWM signal based on the rising signal of the PWM signal, the falling signal of the PWM signal, and the pulse number of the PWM signal. The pulse width generation can include a first multiplexer configured to receive a 0 value at the rising edge of the PWM signal, the falling edge of the PWM signal, and the falling edge of the touch synchronization signal and outputs a count value by adding a count; a first counter configured to store and output a count value of the first multiplexer; a second multiplexer configured to receive a count value from after the rising edge of the PWM signal occurs until the falling edge of the PWM signal occurs; a first register configured to store and output a count value corresponding to the high pulse width of the PWM signal based on the count value of the second multiplexer; a third multiplexer configured to receive a count value from after the falling edge of the PWM signal occurs until the rising edge of the PWM signal occurs; a second register configured to store and output a count value corresponding to the low pulse width of the PWM signal based on the count value of the third multiplexer; a fourth multiplexer configured to receive a count value from after the falling edge of the touch synchronization signal occurs until the rising edge of the first pulse occurs; and a third register configured to store and output a count value corresponding to the initial interval of the PWM signal based on the count value of the fourth multiplexer.

The pulse number generation can include a fifth multiplexer configured to receive a 0 value at the falling edge of the touch synchronization signal and outputting a count value by adding a count; a second counter configured to store and output a count value of the fifth multiplexer; a sixth multiplexer configured to receive a count value from after the falling edge of the touch synchronization signal occurs until the rising edge of the touch synchronization signal occurs; and a fourth register configured to store and output a count value corresponding to the number of pulses of the PWM signal based on the count value of the sixth multiplexer.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present disclosure. Further, although the operating effects according to the configuration of the present invention are not explicitly described while describing an embodiment of the present invention, it should be appreciated that predictable effects are also to be recognized by the configuration.

What is claimed is:

1. A display device comprising:
a microcontroller configured to operate in an active mode and an idle mode, and comprising a core circuit configured to determine a touch position in the active mode, a clock generator configured to generate a clock signal, and a first Pulse Width Modulation (PWM) generator configured to generate a PWM signal in the active mode using the clock signal;
a touch driver comprising a second PWM generator configured to generate a PWM signal based on a high pulse width, a low pulse width, a pulse count, and initial interval information of a PWM signal generated by the first PWM generator, wherein the touch driver determines whether a touch has occurred in the idle mode, and the second PWM generator operates off in the active mode;
a timing controller configured to generate a touch synchronization signal supplied to the microcontroller and the touch driver; and
a plurality of touch electrodes configured to receive a common voltage generated based on the PWM signal of either of the first PWM generator or the second PWM generator and driven in the active mode or the idle mode.

2. The display device of claim 1, wherein the first PWM generator operates on in a first frame of the idle mode and off in a second frame of the idle mode.

3. The display device of claim 1, wherein the microcontroller further comprises,
a Serial Peripheral Interface (SPI) master configured to perform bidirectional data communication between peripheral devices using an SPI signal;
a Random Access Memory (RAM) configured to store touch data included in the SPI signal; and
an interrupt request (IRQ) detection unit configured to receive an interrupt signal and completes reception of the touch data.

4. The display device of claim 3, wherein the SPI master and the RAM operate in the active mode and do not operate in the idle mode, and the IRQ detection unit operates in the active mode and the idle mode.

5. The display device of claim 2, wherein the second PWM generator counts the high pulse width, low pulse width, pulse number, and initial interval information of the PWM signal generated by the first PWM generator during the first frame of the idle mode, and generates a PWM signal based on count values of the high pulse width, low pulse width, and initial interval information of the PWM signal from the second frame onwards of the idle mode.

6. The display device of claim 1, wherein the second PWM generator comprises:
a pulse width generation configured to count the high pulse width, the low pulse width, and the initial interval information of the PWM signal and output respective counts of a rising signal of the PWM signal and a falling signal of the PWM signal;
a pulse number generation configured to count pulses of the PWM signal, and store the pulse count of the PWM signal; and
a pulse generation configured to generate the PWM signal based on the rising signal of the PWM signal, the falling signal of the PWM signal, and the pulse count of the PWM signal.

7. The display device of claim 6, wherein the pulse width generation comprises:
a first multiplexer configured to receive a 0 value at a rising edge of the PWM signal, a falling edge of the PWM signal, and a falling edge of the touch synchronization signal, adding a count at each of the rising edge of the PWM signal, the falling edge of the PWM signal, and the touch synchronization signal to produce a count value, and output the count value;
a first counter configured to store and output the count value of the first multiplexer;
a second multiplexer configured to receive the count value from after the rising edge of the PWM signal occurs until the falling edge of the PWM signal occurs;
a first register configured to store and output the count value corresponding to the high pulse width of the PWM signal based on a count value of the second multiplexer;
a third multiplexer configured to receive a count value from after the falling edge of the PWM signal occurs until the rising edge of the PWM signal occurs;
a second register configured to store and output a count value corresponding to the low pulse width of the PWM signal based on the count value of the third multiplexer;
a fourth multiplexer configured to receive a count value from after the falling edge of the touch synchronization signal occurs until the rising edge of a first pulse of the PWM signal occurs; and
a third register storing and outputting a count value corresponding to an initial interval of the PWM signal based on the count value of the fourth multiplexer.

8. The display device of claim 7, wherein the pulse width generation outputs a falling signal of the PWM signal at a moment when the first counter counts a count value corresponding to the high pulse width, outputs a rising signal of the PWM signal at a moment when the first counter counts a count value corresponding to the low pulse width, and outputs a rising signal of the PWM signal at a moment when the first counter counts a count value corresponding to the initial interval of the PWM signal.

9. The display device of claim 7, wherein the pulse width generation further comprises an average generator configured to calculate an average of the high pulse width of the PWM signal and supply the average of the high pulse width to the second multiplexer, and configured to calculate an average of the low pulse width of the PWM signal and supply the average of the low pulse width to the third multiplexer.

10. The display device of claim 6, wherein the pulse number generation comprises:
a fifth multiplexer configured to receive a 0 value at the falling edge of the touch synchronization signal and outputting a count value by adding a count;
a second counter configured to store and outputting a count value of the fifth multiplexer;
a sixth multiplexer configured to receive a count value from after the falling edge of the touch synchronization signal occurs until the rising edge of the touch synchronization signal occurs; and
a fourth register configured to store and outputting a count value corresponding to a number of pulses of the PWM signal based on the count value of the sixth multiplexer.

11. The display device of claim 10, wherein the pulse number generation generates a PWM enable signal maintaining a high-level from a time the falling edge of the touch synchronization signal occurs until the count value of the fifth multiplexer reaches a target value based on the count value stored in the fourth register.

12. The display device of claim 6, wherein the pulse generation comprises:
a seventh multiplexer configured to receive a 0 value at the falling edge of the touch synchronization signal, receive a 0 value at the falling edge of the PWM signal, and receive a 1 value at the rising edge of the PWM signal; and
a fifth register configured to generate a low-level of the PWM signal when receiving a 0 value from the seventh multiplexer, and generate a high-level of the PWM signal when receiving a 1 value from the seventh multiplexer.

13. The display device of claim 1, wherein the touch driver comprises a first touch driver and a second touch driver,
the first touch driver is configured to generate a PWM signal based on a PWM signal generated by the first PWM generator, and comprises the PWM generator, and
the second touch driver is configured to receive a common voltage generated based on the PWM signal generated by the first touch driver.

14. The display device of claim 1, wherein the touch driver sequentially supplies a common voltage to each of a plurality of channel multiplexers connected to the plurality of touch electrodes in the active mode, and simultaneously supplies a common voltage by merging the plurality of channel multiplexers into one group in the idle mode.

15. A display device comprising:
a microcontroller configured to operate in both an active mode and an idle mode, and comprising a first Pulse Width Modulation (PWM) generator configured to generate a PWM signal in the active mode for determining a touch position;
a touch driver comprising a second PWM generator configured to generate a PWM signal based on a high pulse width, a low pulse width, a pulse count, and initial interval information of a PWM signal generated by the first PWM generator in the idle mode for determining whether a user's touch occurs; and
a plurality of touch electrodes configured to receive a common voltage generated based on the PWM signal of either of the first PWM generator or the second PWM generator to be driven in the active mode or the idle mode, wherein portions of the microcontroller operate at a reduced speed and power consumption in idle mode as compared to active mode.

16. The display device of claim 15, wherein the first PWM generator operates on in a first frame of the idle mode and off from a second frame onwards of the idle mode.

17. The display device of claim 16, wherein the second PWM generator counts the high pulse width, the low pulse width, the pulse count, and the initial interval information of the PWM signal generated by the first PWM generator during the first frame of the idle mode, and generates a PWM signal based on count values of the high pulse width, the low pulse width, and the initial interval information of the PWM signal from the second frame onwards of the idle mode.

18. The display device of claim 17, wherein the second PWM generator comprises:
a pulse width generation configured to count the high pulse width, the low pulse width, and the initial interval information of the PWM signal and output respective counts of a rising signal of the PWM signal and a falling signal of the PWM signal;
a pulse number generation configured to count and store a pulse count of the PWM signal; and
a pulse generation configured to generate the PWM signal based on the rising signal of the PWM signal, the falling signal of the PWM signal, and the pulse count of the PWM signal.

19. A touch screen controller configured to operate in an active mode and an idle mode, the touch screen controller comprising:
a microcontroller comprising a core circuit configured to determine a touch position in the active mode and a first Pulse Width Modulation (PWM) generator configured to generate a PWM signal in the active mode;
a second PWM generator configured to generate a PWM signal based on information generated by the first PWM generator; and
a plurality of touch electrodes configured to receive a common voltage generated based on the PWM signal of the first PWM generator in the active mode and the PWM signal of the second PWM generator in the idle mode,
wherein during the active mode, in response to an absence of a touch detected via the touch electrodes, the touch screen controller switches to the idle mode where the core circuit and the first PWM generator lower their power consumption, and
wherein during the idle mode, in response to a touch detected via the touch electrodes, the touch screen controller switches to the active mode where the core circuit and the first PWM generator operate increase their power consumption and the second PWM generator lowers its power consumption.

20. The touch screen controller of claim 19, wherein the first PWM generator operates on in a first frame of the idle mode and off in a second frame of the idle mode.
